(19) United States
(12) Patent Application Publication
(10) Pub. No.: US 2014/0134873 A1
(43) Pub. Date: May 15, 2014

(54) LINE AND METHOD FOR ASSEMBLING SUCH A LINE

(71) Applicant: Lutz Lehmann, Vilsbiburg (DE)

(72) Inventor: Lutz Lehmann, Vilsbiburg (DE)

(73) Assignee: LISA DRAEXLMAIER GmbH, Vilsbiburg (DE)

(21) Appl. No.: 14/128,405

(22) PCT Filed: Jun. 18, 2012
(86) PCT No.: PCT/EP2012/061564

§ 371 Date: Dec. 20, 2013

(30) Foreign Application Priority Data
Jun. 21, 2011 (DE) 10 2011 077 888.8

(51) Int. Cl. H01R 4/20; H01R 43/20; H01R 4/24

(52) U.S. Cl. CPC H01R 4/20; H01R 4/2495; H01R 43/20
USPC 439/421; 439/879; 29/857

(57) ABSTRACT

A line includes a cable, a sleeve, and a contact member. The cable includes a conductive member including a plurality of strands. The sleeve at least partially surrounds the strands. The contact member includes a core disposed between the strands and contacting with the strands, and a fastening portion at least partially surrounded by the sleeve. An outer surface of the fastening portion connects with an area of the sleeve.

The present invention relates to a line, which is designed in particular for use in vehicles, in particular in motor vehicles, and a method for its assembly. In this context, line assembly refers in particular to the manufacture of cables ready for connection, cable bundles and entire wiring harnesses with plugs, contacts, as well as ferrules. In particular, this concerns the contacting of conductors of such cables with a contact member, e.g., a plug, by a magnetic forming process. These cables may in particular be used to supply electrical power to electric consumers. However, their use for the grounding of electrical systems is likewise conceivable.

Especially in automotive engineering, there has long been a desire to manufacture electric cables made of light metal, such as magnesium or aluminum, and their alloys, for weight saving reasons and substitution of expensive metals with lower-cost alternatives. However, when these cables, which, particularly in motor vehicles are subject to a dynamic load over a long period of many years, are brought into electrical contact with a contact member, contact maintenance problems occur, especially due to the cold-flow tendency of the material, i.e., the tendency of light metals, such as aluminum and magnesium, to reduce mechanical stresses in the structure, even at low temperatures, and due to the presence of an oxide film on the surface of the aluminum alloy, and finally due to the risk of electrochemical corrosion in the junction area of the light-metal strands with the contact members in the absence of an electrolyte.

To solve this set of problems, German patent DE 10 2010 003 599 A, which represents post-published prior art, proposes a line comprising a cable with an exposed conductive member in the form of a strand bundle, which is partially surrounded by a contacting sleeve and contacts a core of a contacting member, which is disposed between the strands of the bundle, due to magnetic forming of the contacting sleeve. Although this approach has already delivered satisfactory results, particularly the connection between the cable and the contact member should be improved, particularly against tensile loads, and optionally sealing of the exposed conductive member against longitudinal water penetration should be achievable.

Against this background, an object of the present invention is to provide a line and a method for assembling a line of the initially mentioned type, with which the connection between the contact member and the cable will be improved over the prior art.

This object is solved by a line having the features of Claim 1, and by a method having the features of Claim 11. Advantageous further developments of the present invention are shown in the dependent claims.

The present invention is based on the idea of connecting the sleeve with the strand bundle, not only via the magnetic forming process, but more importantly, by also providing fastening of the sleeve on the contact member itself. Thus, the contact member is retained on the cable, via the core located between and connected with the strands, optionally via the connection of the sleeve with the strand bundle, especially the outside thereof, as is the connection of the sleeve with the contact member. As a result, the contact member is reliably and securely fastened to the line.

Accordingly, the present invention defines a line or an assembled line designed for use in vehicles, preferably automotive vehicles. It includes a cable, which may be, e.g., a coaxial cable or a shielded cable, or a conventional cable with a conductor and a surrounding protective sheath (the insulation). Furthermore, a sleeve, partially (preferably completely) surrounding the strand bundle lengthwise, is provided. The sleeve is formed from an electrically conductive material in order to be formed as part of a magnetic forming process. Magnetic forming is an electrodynamic, high-energy forming process for cold forming from electrically conductive materials by electromagnetic pulse technology (EMPT). In this process, the semi-finished product, in this case the sleeve, is positioned within a coil, optionally comprising an interconnected field transformer, and contactlessly formed due to the force effect of a pulsed magnetic field force of very high intensity, i.e., in contrast to crimping, without mechanical contact with the tool. Thus, with the magnetic forming process, uniform and symmetric distribution of force may be applied to the sleeve along its circumference, such that uniform formation of the sleeve along its circumference results and with no mechanical stress on the outer surface of the sleeve. Furthermore, a contact member is electrically connected with the strand bundle, i.e., contacted therewith. Accordingly, the contact member has a core, which is disposed between the strands of the bundle, preferably between the strands of the bundle in a substantially central fashion and forming the connection between the strands and the contact member. Contacting or connection of the core with the strand bundle occurs thereby primarily by magnetic forming of the sleeve, as is known from German patent GE 10 2010 003 599. The core thereby acts primarily as an counter-bearing. Thus, a material-locking connection between the sleeve and the strands, among the strands, and between the strands and the core occurs. The contact member may be, for example, a plug or a cable lug, or other well-known contact members. According to the invention, the contact member also has a fastening portion adjacent to the core. The fastening portion preferably has a rotationally symmetric shape. Advantageously, it also has a fastening surface, which is defined as an outer surface. The outer surface may also be referred to as the shell of the fastening portion. Furthermore, according to the invention, the sleeve adjacent to the strand bundle with the introduced core surrounds, at least partially, the fastening portion of the contact member, and is connected with the outer surface thereof by magnetic forming of the sleeve in order to realize reliable fastening of the sleeve on the contact member and thus securely fasten the contact member on the cable. This embodiment is particularly advantageous, when a sleeve made of aluminum is connected with a strand bundle consisting of aluminum strands, since then no corrosion occurs in the area between the strand bundle and the sleeve. In this case, the core and/or the fastening portion may be formed of copper, whereby between the sleeve made of aluminum and the core and/or fastening portion made of copper, a form-locking, e.g., crimped, although preferably material-locking, large-area connection with minimized risk of corrosion is created. In other words, it is preferred that here too, a material-locking connection at the contact surfaces between the inside of the sleeve and the fastening portion is achieved. This may likewise be realized with the above-mentioned magnetic forming process.

In order to provide an optimally secure connection, it is advantageous that the core continues integrally from the fastening portion in the longitudinal direction of the contact member or the cable. The core and the fastening portion, and the core made of a bondable non-ferrous metal, may be manufactured in one piece by extrusion molding, turning, forging, etc. An optional plug, e.g., a plug part and/or cable lug may similarly be manufactured of a non-ferrous metal, as a stamped/bent part by forging, turning, etc., and connected by riveting, welding, pressing, etc., with the fastening portion and the core.

Furthermore, the sleeve, the core, the fastening portion and the contact member may be of a modular design. This means that, for instance, the sleeve, the core and the fastening portion may be designed for a corresponding conductor diameter and that the fastening portion may be connected with different types of contact members. Thus, inventory may be reduced considerably, as the same sleeves, cores and fastening portions are always used and only the contact member is subject to adjustment, as needed.

Moreover, it is advantageous that the core and/or the fastening portion are designed to taper in the longitudinal section, and from the cable end toward the contact member. According to a particularly preferred embodiment, the core and/or fastening portion are formed in a cone-shaped manner. This has the advantage of ensuring a secure hold of the contact member between the strands or in the sleeve against tensile stress on the contact member or cable. Thus, in addition to the material-locking connection, a form-locking, but also a force-locking connection, is primarily created. In the area of the core, the strands are thus held together by the sleeve. Also, independently of the inventive idea of the fastening portion, the tapered shape of the core is realizable in order to improve retention of the contact member in the longitudinal direction of the cable.

Further, it is advantageous to design the outer dimension of the fastening portion to be greater in the radial direction than that of the core, which especially applies to the junction between the core and the fastening portion. Thus, it can be ensured that during manufacture, the front ends of the strands of the strand bundle abut the front end of the fastening portion facing the end of the strand, while inserting the core between the strands, and thus automatically creating an end stop, which limits the insertion of the core into the strand bundle, without the need for further action.

To prevent surface corrosion and longitudinal ingress of water into the area of the strand bundle, it may be advantageous to dispose one or more sealing members between the sleeve and the cable or the sleeve and the fastening portion, which member(s) is/are pressed during magnetic forming through the sleeve in sealing contact against the outer surface of the cable or the fastening portion, thereby preventing longitudinal ingress of water at the interface between the sleeve and the outer surface of the cable, e.g., the outer surface of the insulation and the outer surface of the fastening portion. Thus additional corrosion protection can be achieved effectively and without additional process steps. This way, a hermetically sealed space can be achieved in the area of contacting, which sealed space on the one hand is achieved in the area of the material-locking connection between the sleeve and the fastening portion, and on the other, by the seal between the sleeve and the outer surface of the cable. Furthermore, together with the material-locking connection of the inside of the sleeve with the strands, the strands with one another, and the strands with the core, a gas-tight connection between the conductor and the contact member is realized in this way. It is particularly preferred here that the sleeve of the contact member extends beyond the strand bundle up to an outer insulation surrounding the strand bundle and that a sealing member be disposed between the sleeve and the outer insulation. The sealing member(s) may thus be received in a recess of the sleeve.

Moreover, it is also conceivable to use the present invention, when connecting a coaxial cable with a coaxial plug. The cable then usually has a conductor and an inner insulation or a dielectric material surrounding the conductor, and a shield is disposed between the inner insulation or the dielectric material and the insulation. In order advantageously to connect the cable with a coaxial plug in a simple and cost-efficient way at low cycle times in an achievable way, it is preferable that the sleeve has at least one cutting edge facing the insulation and projects radially from the inner surface of the mostly cylindrical sleeve. The cutting edge is preferably formed as tapered in the cross-section to allow easy penetration into the insulation. The sleeve is formed by magnetic forming, i.e., contactlessly, and pressed against the insulation, whereby the cutting edge fully penetrates the insulation and is at least in contact with the shield. Advantageously, the cutting edge will penetrate, at least slightly, i.e., partially, into the shield to ensure reliable contacting. Thus, with magnetic forming, the depth of penetration of the cutting edge can be adjusted optimally and repeatably in an exact way and along the whole circumference, such that damage to the shield itself or its underlying layers can be prevented. Moreover, a simple and uncomplicated design is retained.

To prevent contact between the part of the contact member connected with the conductor and the sleeve, it may be preferable to provide insulation on the inside of the sleeve in the area, where it contacts the strand bundle and/or the fastening portion. Alternatively or additionally, insulation may, of course, be provided on the fastening portion. In a further alternative, the core with the connected plug may be formed separately from the fastening portion, and insulation provided between the fastening portion and the core.

Besides the line described above, the present invention also proposes a method for assembling such a line. In this case, a sleeve is placed on a cable that is at least partially stripped, such that the strand bundle of a conductive member is exposed at one end of the cable. Furthermore, a core of a contact member is introduced or inserted between the strands of a strand bundle of a conductive member of the cable. Here, centered or substantially centered insertion between the strands of the strand bundle is preferred, such that the core substantially forms a centered counter-bearing. After insertion of the core, the sleeve is slid over the strand bundle, such that it preferably fully surrounds the strand bundle in the area, in which the core was introduced, and at the same time a fastening portion of the contact member. In a further process step, the sleeve is subjected to a magnetic field, at least in the areas, in which the sleeve surrounds the strand bundle with the introduced core, as well as the fastening portion, in order to form the sleeve. Here, on the one hand, the sleeve is connected with the fastening portion and, on the other, at least the core is connected with the strand bundle. Advantageously, a connection between the sleeve and the outer side of the strand bundle may be additionally realized. The core according to the invention serves as a counter-bearing with respect to the sleeve or the strand bundle, when applying the magnetic field to the sleeve, such that the strands are connected with the core, the sleeve, as well as each other in a form-locking, force-locking and preferably material-locking way by welding. For example, an aluminum conductor may thus be connected with a contact member made of copper with corrosion problems.

It is particularly preferable, here, that magnetic forming of the sleeve occurs simultaneously in both areas, such that a connection between the core and the strand bundle, as well as the fastening portion and the sleeve, can be realized at the same time in order to substantially reduce the cycle times of the manufacturing process. Furthermore, it is especially preferred that a differently designed field transformer be used in the longitudinal direction. Here, on the one hand, the field transformer is disposed in the areas for connecting the sleeve with the strand bundle or the strand bundle comprising the core, and on the other, for connecting the sleeve with the fastening portion. If, for example, the sleeve has differing radial dimensions in these areas, such as differing outer diameters, then the split field transformer may be adjusted according to these outer dimensions. Usually, contact members has a housing consisting of a non-conductive material for protecting the junction. According to an advantageous embodiment, the sleeve and/or the contact member is/are at least partially received or preassembled in such a housing consisting of a non-conductive material. The latter is advantageously placed or slid along with the sleeve and/or the contact member onto the cable. Magnetic forming is subsequently performed advantageously by applying a magnetic field through the housing onto the sleeve. This allows for the plug to be preassembled. It is likewise conceivable that sealing of the housing in the cable's longitudinal direction together with the aforementioned sealing members is achieved at the same time.

Further advantages and features of the present invention, which are implementable separately or in combination with one or more of the above features, provided they do not contradict one another, are found in the following description of preferred embodiments of the present invention. These follow with reference to the accompanying drawings, where:

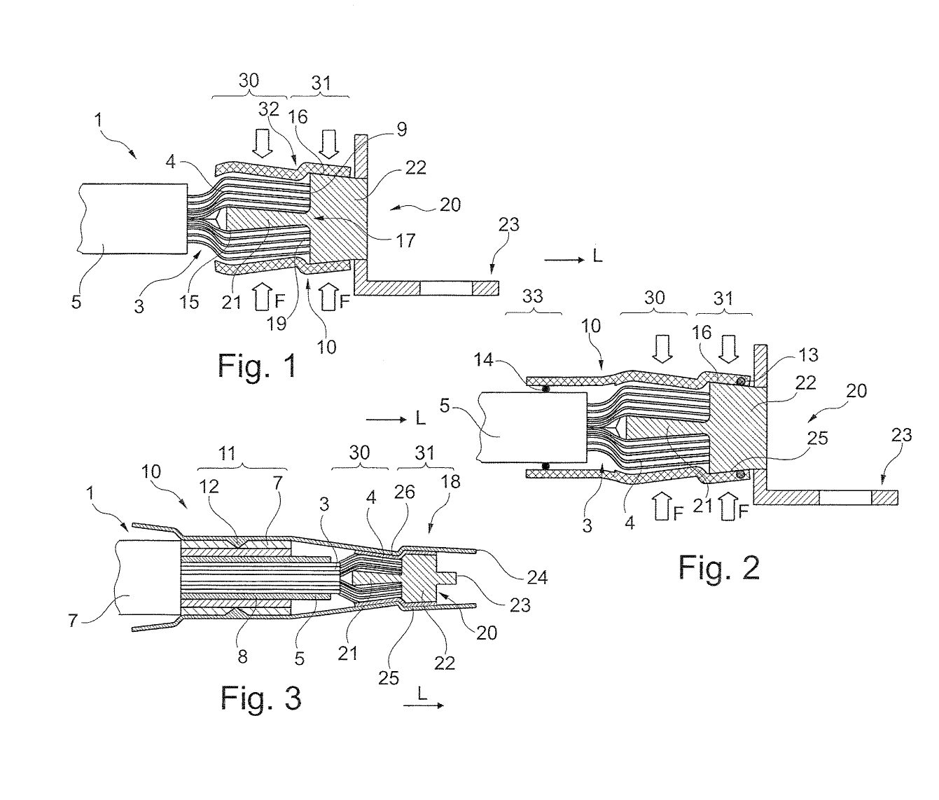

FIG. 1 shows a longitudinal section through a line according to a first embodiment of the present invention;

FIG. 2 shows a longitudinal section through a line according to a second embodiment of the present invention; and

FIG. 3 shows a longitudinal section through a line according to a third embodiment of the present invention.

In the drawings, the same reference marks refer to the same or similar elements. Moreover, the description of these elements is not generally repeated. It is understood, however, that the description of an element of an embodiment equally applies to the element or a comparable element of the other embodiment, provided there are no contradictions.

FIG. 1 shows a cable comprising a conductor 3, which is designed as a strand bundle and comprises a plurality of individual strands 4. This may in particular involve an aluminum conductor with strands made of aluminum or an aluminum alloy. Conductor 3 is surrounded by a protective sheath 5, an outer insulation.

At one end of cable 1, the protective sheath 5 is removed, such that cable 1 is stripped at this end.

A contact member 20 is to be electrically connected with this end of cable 1.

Contact member 20 has a core 21 and a fastening portion 22, which are formed integrally in the shown embodiment. They may be manufactured, for example, of a non-ferrous metal by extrusion, turning, forging, stamping, etc. For example, copper may be used as a material. Core 21 is thereby designed as tapering away from the end of cable 1, in particular in a cone-shaped manner. Core 21 is rotationally symmetric and has an outer surface or shell 15. Core 21 and fastening portion 22 may be implemented as one part or as two parts.

Fastening portion 22 is likewise rotationally symmetric. It likewise tapers starting from the junction with core 21 and away from the end of cable 1. Fastening portion 22 is also cone-shaped in this embodiment. It has an outer surface or shell 16. Core 21 and fastening portion 22 are disposed behind one another in the cable's longitudinal direction L. The outer diameter of the fastening portion 22 at junction 17 between the fastening portion 22 and core 21 is greater than the outer diameter of core 21 at junction 17. The former is, in particular, also substantially greater than the maximum outer diameter of core 21. Fastening portion 22 thus forms a front end 19. In the assembled state, the front ends 9 and the ends of strands 4 of strand bundle 3 abut the front end 19. The front end 19 thereby provides an end stop, when the core 21 for the strands 4 of the strand bundle 3 is inserted or introduced.

A connecting member 23, is connected with the fastening portion 22, for example, by riveting, welding, pressing, etc. In the illustration in FIG. 1, this involves a cable lug.

Furthermore, a sleeve 10 is provided. Likewise, sleeve 10 is preferably rotationally symmetric. In the shown embodiment, this sleeve is divided into a first section 30 and a second section 31. Section 30 and section 31 are thereby joined by a step 32. Further, section 31 and section 30 are designed according to the taper of core 21 and fastening portion 22, i.e., sleeve 10 may also be composed of two tapered sections. Sleeve 10 is likewise advantageously formed of aluminum or an aluminum alloy.

For connection, a magnetic field is placed on sleeve 10, optionally with a two-part field transformer adapted to the external geometry of the sleeve, thereby applying a force F along the circumference of the sleeve. This will magnet-form sleeve 10, whereby, in the shown embodiment, it forms a connection with the outer strands 4. Thus, contacting, preferably connection of the individual strands 4 with core 21, likewise occurs. Following the connection process, even if no connection of core 21 with the strands 4 comes about, the conical design of core 21 prevents it from slipping out of the strand bundle. Besides the material-locking connection, a form-locking connection in the longitudinal direction is also added, whereby the strands are held together by the sleeve. In addition, connection of sleeve 10 with the outer surface 16 of fastening portion 22 occurs, thereby securely connecting sleeve 10 with contact member 20 and strand bundle 4. In particular, a material-locking, large-area connection is obtained by welding with a minimized risk of corrosion. Sleeve 10 generally enters into a material-locking connection with strands 4, which causes a reliable fixation of the contact member 20 at the conductor end. Advantageously, magnetic forming of sleeve 10 is done simultaneously in both areas 30 and 31, so as to keep cycle times low. However, separate forming processes are also conceivable.

Furthermore, it may be advantageous to incorporate sleeve 10 in a housing of a non-conductive material and apply the magnetic field through the housing onto the sleeve in order to contact a preassembled plug without the need for subsequent mounting steps.

In order to ensure further surface corrosion protection and in particular prevent longitudinal ingress of water into the junction, it may be advantageous, as shown in FIG. 2, that a sealing member, e.g., a sealing ring 13 be disposed between one inside 25 of sleeve 10 and an outer surface 16 of the fastening portion 22. For this purpose, a groove or recess, in particular an annular recess in the outer surface 16 of fastening portion 22 or the inner surface 25 of sleeve 10 may be provided in order to receive sealing ring 13. Sealing member 13 thereby protrudes over the respective inner and outer side 25, 16. During magnetic forming in area 31, sealing member 13 is compressed between the surfaces 16, 25, and thus provides reliable sealing. Alternatively, as sealing member 13, a paste-like mass may be used, which is disposed between sleeve 10 and fastening portion 22 and/or sleeve 10 and the strand bundle 4. The pasty sealing material on the strands 4 may be compressed and/or pressed into strands 4 by magnetic forming.

Moreover, it may be advantageous and expedient to extend sleeve 10 in the longitudinal direction L, such that in the assembled state, it reaches an area, in which the insulation of conductor 3 is not stripped, i.e., an area 33, in which it also surrounds the protective sheath 5 of conductor 1. In order to prevent complete longitudinal ingress of water into the connection portion, it may be advantageous in this area, too, between the inside of sleeve 10 and the outer surface of insulation 5, to insert a sealing member 14 and perform magnetic forming in this area 33 in order to press sealing member 14 in between the inside of sleeve 10 and the outer surface 5 of the insulation. Optionally, only one protrusion on the inside of sleeve 10 may be formed at this location, pushing into the resilient insulation 5 in order to achieve a sealing effect. Since the insulation 5, per se, has a certain elasticity, it may be advantageous only to sandwich sealing member 14 in between in this area. However, it is similarly conceivable to provide a recess on the inside of sleeve 10, as described above in reference to sealing member 13. It is, of course, furthermore possible to omit the recess for sealing member 13 and only insert it between the surfaces. Nevertheless, the use of recesses is advantageous, which will allow for sealing members 13, 14 to be preassembled and prevent their slipping or loss, when being slid on.

Otherwise, the embodiment in FIG. 2 does not differ from the one in FIG. 1, hence reference will be made to the above embodiments.

Finally, the present invention is also applicable for a coaxial plug, as will be explained below with reference to FIG. 3.

In order to form a coaxial plug, sleeve 10 advantageously extends beyond the fastening portion 22, and forms, on its end 18 facing away from the cable, the outer coaxial part 24 of the coaxial plug. The inner coaxial part is the plug or pin 23

Advantageously, the contacting of contact member 20 is done with conductor 3, whereby the strands or the single conductor 4 of the conductor are/is pushed apart by core 21. The sleeve 10 extends such that it surrounds the strands 4 of conductor 3 in a second contacting area 30, core 21 having been introduced into or between said strands. Moreover, by applying a magnetic field directly on the sleeve 10 in the second contact area 30, or alternatively through a housing, the contacting sleeve 10 is plastically formed (transformed) in contacting area 30, whereby the strands 4 are pressed against the core 21 acting as a counter-bearing, and contacting of the strands 4 with the core 21, and hence with the contact member 20 or the plug 23, occurs. In addition, the sleeve 10 also extends beyond the contact member 20, such that it surrounds the fastening portion 22. The fastening portion 31 is disposed here, and it is pressed against the fastening portion 22 of the contact member 20 during magnetic forming of the sleeve 10, such that a firm connection of the contact member 20 with sleeve 10 ensures.

Also, sleeve 10 has a substantially cylindrically formed contacting portion 11. A cutting edge 12 is provided in this contacting portion 11, and it extends radially inwardly from the radial inside 14 of contacting sleeve 10. The cutting edge 12 is preferably formed integrally with sleeve 10. What's more, cutting edge 12 preferably proceeds radially inward in a tapered fashion for improved cutting effect. During magnetic forming in portion 11, the cutting edge fully penetrates the outer insulation 7 and contacts shield 8, i.e., comes into contact with shield 8. However, it is also conceivable that the cutting edge 12 penetrates, at least slightly, shield 8 so as to ensure reliable contacting. However, the depth of penetration should thereby preferably be less than 50% of the radial thickness of the shield 8, preferably less than 30%, and most preferably less than 15% of the thickness of the shield in the radial direction.

For this purpose, sleeve 10 is transformed by magnetic forming, at least in the contacting portion 11, such that, when plastically transformed, it is pressed onto the external insulation 7. This occurs due to a magnetic forming process, in which, due to this magnetic forming process, a force F is exerted at least in the contacting portion 11 along the periphery of the contacting sleeve 10, such that the contacting sleeve 10 is plastically transformed in this area and pressed against the outer surface of the outer insulation 7. During this process, the cutting edge 12 penetrates the outer insulation 7 along the circumference, passes through the latter and comes into contact with shield 8, or penetrates partially into the latter, as described above. As magnetic forming occurs simultaneously in portions 11, 30 and 31, contacting of contacting sleeve 10 with shield 8, contacting of core 21, i.e., contacting member 20, with the individual wires 4, and also fastening of the contacting sleeve 10 on the fastening portion 22 of the contact member 20, or vice versa, may take place in one process step. To prevent electrical connection between the contact member 20 and the contacting sleeve 10, an electrical insulation is preferably disposed between the inside 14 of the contacting sleeve 10 in the area of the strands 4 and/or the fastening portion 22, preferably between both. A sealing member (not shown) may also be disposed in the area of the fastening portion 22, as explained with reference to FIG. 2, in order to realize longitudinal watertightness, including at the junction between the fastening portion 22 and the inside 14 of contacting sleeve 10. With this embodiment in FIG. 3, a coaxial cable connector is connected to a coaxial cable in the simplest way. Advantageously, the sleeve may even be preassembled in a housing, or formed integrally with the housing, and magnetic forming may take place through the housing.

It shall be understood that the present invention was explained only by way of examples based on the above embodiments and that different variations and modifications are conceivable. It is also possible to combine individual aspects of the different embodiments of the figures with one another, unless these individual aspects are contradicting.

1.-12. (canceled)

13. A line comprising:
a cable including a conductive member, the conductive member including a plurality of strands;
a sleeve at least partially surrounding the strands; and
a contact member including:
a core disposed between the strands and contacting with the strands; and
a fastening portion at least partially surrounded by the sleeve, an outer surface of the fastening portion connecting with an area of the sleeve.

14. The line of claim 13, wherein the core and the fastening portion form an integral member.

15. The line of claim 13, wherein the core has a cone shape.

16. The line of claim 13, wherein the fastening portion has a cone shape.

17. The line of claim 13, wherein an external dimension of the fastening portion in a radial direction is greater than an external dimension of the core in the radial direction.

18. The line of claim 17, wherein an end of the conductive member abuts a front end of the fastening portion facing the conductive member.

19. The line of claim 13, further comprising:
a sealing member between the sleeve and the cable, the sealing member being pressed against and contacting an outer surface of the cable.

20. The line of claim 19, wherein:
the sleeve extends from the contact member to an outer insulation surrounding a portion of the conductive member, and
the sealing member is disposed between the sleeve and the outer insulation.

21. The line of claim 19,
wherein the sealing member is a first sealing member, and
the line further comprises:
a second sealing member between the sleeve and the fastening portion, the second sealing member being pressed against and contacting an outer surface of the fastening portion.

22. The line of claim 13, further comprising:
a sealing member between the sleeve and the fastening portion, the sealing member being pressed against and contacting an outer surface of the fastening portion.

23. The line of claim 13, wherein:
the cable includes:
an inner insulation surrounding a portion of the conductive member;
an outer insulation surrounding at least a portion of the inner insulation; and
a shielding layer disposed between the inner insulation and the outer insulation,
the sleeve extends to cover a portion of the outer insulation, and
the sleeve includes a cutting edge facing the outer insulation, the cutting edge completely penetrating the outer insulation and contacting the shield layer.

24. The line of claim 23, wherein the cutting edge partially penetrates the shielding layer.

25. The line of claim 23, further comprising:
an insulation provided between the sleeve and the conductive member.

26. The line of claim 25, wherein the insulation is provided between the sleeve and the fastening portion.

27. The line of claim 23, further comprising:
an insulation provided between the sleeve and the fastening portion.

28. A method for assembling a line comprising:
placing a sleeve over a cable having a conductive member, the conductive member including a plurality of strands;
inserting a core of a contact member between the strands, the core including a fastening portion connected with the core;
sliding the sleeve over the conductive member, such that the sleeve surrounds a portion of the conductive member and at least a portion of the fastening portion; and
performing magnetic forming on the sleeve, at least in a first area where the sleeve surrounds the conductive member with the core and a second area where the sleeve surrounds the fastening portion, to connect the sleeve with the fastening portion, and at least contact the core with the conductive member.

29. The method of claim 28, wherein performing the magnetic forming includes performing the magnetic forming simultaneously in the first and second areas.

30. The method of one of claim 28, wherein:
the sleeve is received in a housing made of a non-conductive material, and
performing the magnetic forming includes applying a magnetic field through the housing onto the sleeve.
